(19) United States
(12) Patent Application Publication
(10) Pub. No.: US 2008/0076003 A1
(43) Pub. Date: Mar. 27, 2008

(54) Structure of gasket for preventing contamination of fuel cell stack

(76) Inventors: Keun Je Lee, Hwaseong-si (KR); Young Bum Kum, Seoul (KR)

Correspondence Address: MORGAN, LEWIS & BOCKIUS LLP (SF), 2 PALO ALTO SQUARE, 3000 El Camino Real, Suite 700, PALO ALTO, CA, 94306, US

(21) Appl. No.: 11/641,444

(22) Filed: Dec. 19, 2006

(30) Foreign Application Priority Data
Sep. 27, 2006 (KR) 10-2006-0094414

(51) Int. Cl. H01M 2/08

(52) U.S. Cl. 429/35

(57) ABSTRACT

A gasket assembly suitable for use in a fuel cell includes a membrane electrode assembly; a separator comprising a manifold structure having a plurality of apertures; and a gasket disposed between the separator and the membrane electrode assembly. The gasket is positioned and configured to prevent the leakage of fluid from the manifold into the membrane electrode assembly and resultant loss in fuel cell performance. A contamination prevention groove is formed on one side of the gasket to form a channel along which any leaking fluid, e.g. antifeeze, can flow.

### CROSS-REFERENCE TO RELATED APPLICATION

This application claims priority to and the benefit of Korean Patent Application No. 10-2006-0094414 filed in the Korean Intellectual Property Office on Sep. 27, 2006 the entire contents of which are incorporated herein by reference.

### BACKGROUND OF THE INVENTION

(a) Field of the Invention

The present invention relates to a gasket assembly suitable for use in a polymer electrolyte membrane fuel cell.

(b) Description of the Related Art

Fuel cells are well known in the art. Generally, a fuel cell includes a pair of electrodes, an electrolyte membrane, and a separator supporting the electrodes and the electrolyte membrane. One type of fuel cell is a polymer electrolyte membrane fuel cell, which generates electricity, water, and heat through an electrochemical reaction involving hydrogen and oxygen.

The mechanism by which a PEMFC generates electricity is as follows: during fuel cell operation, a fuel such as hydrogen gas (H₂) is distributed over the anode and reacted with a catalyst layer to generate protons and electrons.

The hydrogen ions, or protons, then penetrate the polymer electrolyte membrane and travel towards the cathode while the electrons are conducted through an external circuit to the anode. At the cathode, an oxidant such as oxygen (O₂) combines with electrons from the anode and undergoes reduction to oxygen ions (O²⁻) and reacts with the protons to form water, heat, and electricity.

The reaction that occurs is illustrated as follows:

Anode: H₂→2H⁺+2e⁻

Cathode: ½ O₂+2H⁺+2e⁻→H₂O

The theoretical voltage generated by this process is about 1.3V. To produce a higher voltage, multiple fuel cell units are combined to form a fuel cell stack.

Operation and stopping are frequently repeated in a fuel cell, and contraction and expansion frequently occur by the chemical reaction. A sealing structure of a fuel cell should thus be able to maintain its sealing characteristics under frequent contraction and expansion, and a stress distribution on respective elements of the fuel cell should be uniform during contraction and expansion.

Recently, antifreeze, rather than distilled water, has been used as the coolant in fuel cell stacks. However, antifreeze can impair the ion exchanging characteristics of the membrane electrode assembly and overall fuel cell performance if it leaks from the manifold structure. As such, there is a need in the art for gaskets that can help seal the membrane electrode assembly against the undesirable leaking of fluid, e.g. antifreeze, from the manifold structure.

### SUMMARY OF THE INVENTION

The gasket of the present invention has the advantage of protecting the membrane electrode assembly and other parts of the fuel cell assembly from contamination by fluid leaking from apertures of the manifold structure. In one aspect of the invention, the fuel cell assembly comprises: a membrane electrode assembly; a separator comprising a manifold structure having a plurality of apertures; and a gasket disposed between the separator and the membrane electrode assembly, said gasket comprising a contamination prevention groove on one side that is configured to receive fluid leaking from any one of the apertures.

### BRIEF DESCRIPTION OF THE DRAWINGS

FIG. 1 shows a gasket assembly for use in fuel cells according to an exemplary embodiment of the present invention.

FIG. 2A and FIG. 2B illustrate, using exploded views of the gasket structure, the mechanism by which the gasket of the present invention prevents contamination of the membrane electrolyte assembly in a fuel cell.

### DETAILED DESCRIPTION OF THE PREFERRED EMBODIMENTS

An exemplary embodiment of the present invention will hereinafter be described in detail with reference to the accompanying drawings.

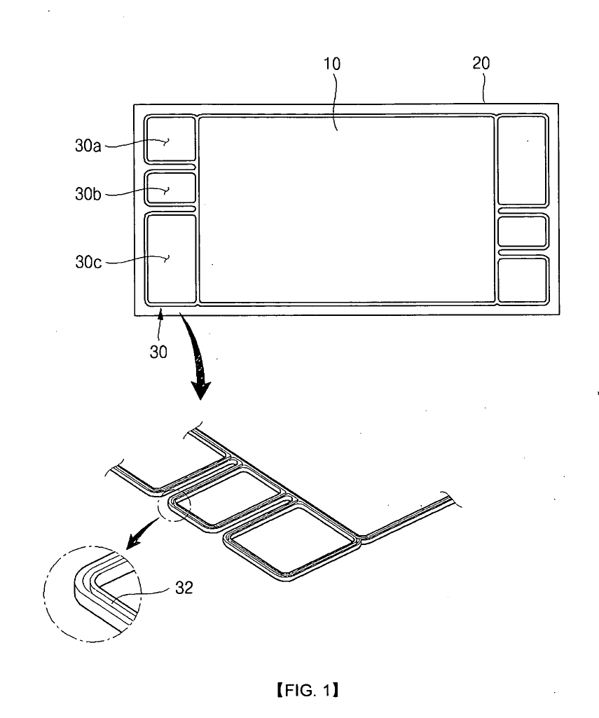

Referring to FIG. 1, a membrane electrode assembly 10 includes a polymer electrolyte membrane (not shown) and a pair of electrodes (not shown). The assembly 10 also includes a separator 20 having a manifold structure with apertures for the flow of oxygen (30c), hydrogen (30a), and antifreeze (30b). FIG. 1 provides an exemplary embodiment of the present invention for illustrative purposes. Those of ordinary skill in the art will recognize that the use of the various apertures of the manifold structure is interchangeable and not restricted to any particular configuration, i.e. aperture 30c for oxygen, aperture 30a for hydrogen, and aperture 30b for antifreeze. In some embodiments of the invention, the gasket 30 is attached at one or more sides of the membrane electrode assembly 10 and is interposed between the separator 20 and the membrane electrode assembly 10. In some embodiments, the gasket 30 is disposed upside or downside of the separator 20. When gasket 30 is disposed on the upside of separator 20, the contamination preventing groove 32 is formed so as to face downwards. When gasket 30 is disposed on the downside of separator 20, the contamination preventing groove 32 is formed so as to face upwards. A contamination prevention groove 32 is formed on one side of the gasket 30 such that antifreeze leaking from an antifreeze aperture 30b of the separator 20 cannot contaminate the membrane electrode assembly 10.

In some embodiments of the invention, the contamination prevention groove 32 has a substantially uniform depth and its cross-section may take a semicircular or polygonal, e.g. triangle, rectangle, trapezoidal, shape.

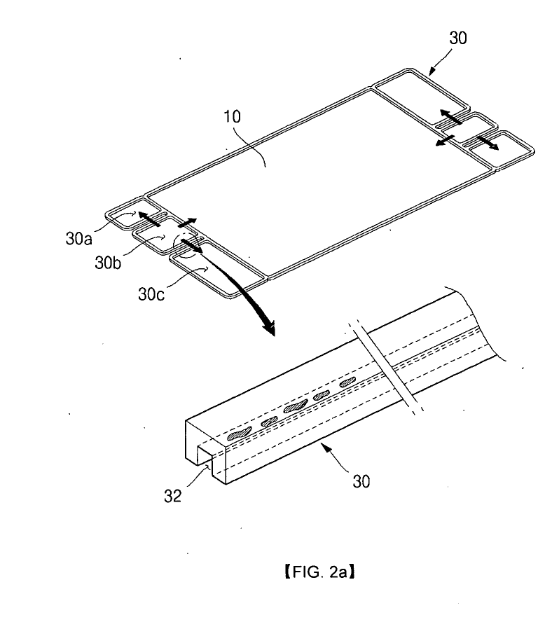

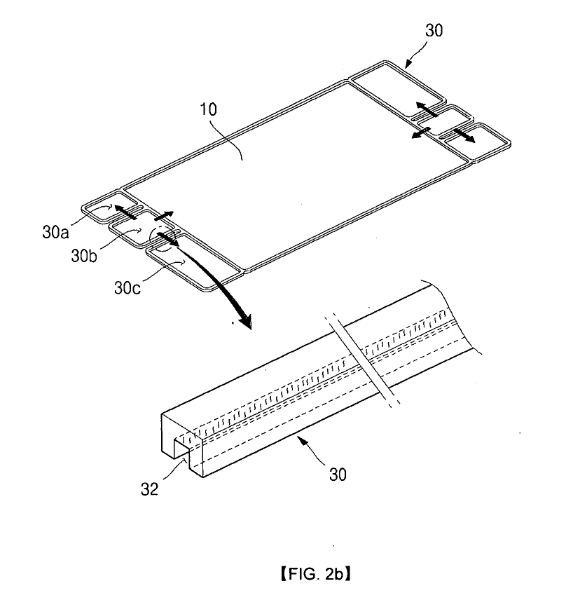

Referring to FIG. 2A, which shows an exploded view of the gasket structure of the invention, any antifreeze that leaks in the directions of the arrows from the antifreeze aperture 30b of the gasket 30 will flow into a region under the gasket 30 rather than into the hydrogen aperture 30a or the oxygen aperture 30c.

Antifreeze in the region under the gasket 30 enters the contamination prevention groove 32 and moves therethrough. Since the contamination prevention groove 32 is positioned along the inner surface of the gasket 30, the antifreeze does not flow into the hydrogen aperture 30a or the air aperture 30c but moves along the contamination prevention groove 32.

Referring to FIG. 2B, while the fuel cell stack, in which a plurality of the ors 20 are piled up, operates, the temperature of the fuel cell stack reaches about 80° . At this temperature, antifreeze leaking from the coolant manifold 30b evaporates in the contamination prevention groove 32, so that the leaked antifreeze does not enter the hydrogen aperture 30a, the oxygen aperture 30c, or the membrane electrode assembly 10, and impair the performance of the fuel cell stack.

Those skilled in the art will appreciate that the conceptions and specific embodiments disclosed in the foregoing description may be readily utilized as a basis for modifying or designing other embodiments for carrying out the same purposes of the present invention. Those skilled in the art will also appreciate that such equivalent embodiments do not depart from the spirit and scope of the invention as set forth herein.

What is claimed is:

1. A fuel cell assembly comprising:
a membrane electrode assembly;
a separator comprising a manifold structure having a plurality of apertures; and
a gasket disposed between the separator and the membrane electrode assembly, said gasket comprising a contamination prevention groove on one side that is configured to receive fluid leaking from any one of the apertures.

2. The fuel cell assembly of claim 1, wherein the contamination prevention groove comprises a substantially uniform depth.

3. The fuel cell assembly of claim 1, wherein the plurality of apertures includes at least one oxygen aperture, at least one hydrogen aperture, and at least one antifreeze aperture.

4. The fuel cell assembly of claim 1, wherein the contamination prevention groove has a cross-section with a substantially semicircular or polygonal shape.
